(19) United States
(12) Patent Application Publication
(10) Pub. No.: US 2005/0210149 A1
(43) Pub. Date: Sep. 22, 2005

(54) Method, system, and computer useable medium to facilitate name preservation across an unrestricted set of TLDS

(76) Inventor: Jordan L. Kimball, Salem, NH (US)

Correspondence Address: Richard C. Litman;LITMAN LAW OFFICES, LTD., P.O. Box 15035, Arlington, VA, 22215, US

(21) Appl. No.: 10/790,876

(22) Filed: Mar. 3, 2004

(51) Int. Cl. G06F 15/16

(52) U.S. Cl. 709/245

(57) ABSTRACT

A method, system, and/or computer useable medium to facilitate name preservation across an unrestricted set of TLDs. TOP LEVEL DOMAIN TOPOLOGY (TLDT) software is executed in a TLDT system. A register is chosen to register a predetermined secondary level domain (SLD) name/inclusive name space for a particular TLD. Data is retrieved for a desired SLD name to register the SLD name in association with at least one TLD in at least one of a Public Root and an Internet Corporation for assigned Names and Numbers (ICANN) Root. A search is conducted of at least one of a Public Root and an ICANN Root and it is determined whether the desired SLD is associated with any TLDs that exist. The desired SLD is registered with all of those TLDs if the user agrees to pay the periodic fee.

### BACKGROUND OF THE INVENTION

1. Field of the Invention

The present invention generally relates to the organization, registration, and naming of Internet domains, and more particularly, to a method, system, and/or computer useable medium to facilitate name preservation across an unrestricted set of Top Level Domains (TLDs).

2. Description of the Related Art

As the Internet becomes increasingly larger, it becomes increasingly more difficult to find content that is relevant to a given topic of inquiry. In the early days of the Internet, when there were a very few hosts, the knowledge of a domain name might have been sufficient to retrieve the desired information. Today it is not, and it has not been so for quite some time.

Two methodologies dominate to facilitate information retrieval on the Internet today, indexing and search engines. Both of these methodologies focus on content that is available using Hyper Text Transport Protocol (HTTP) (e.g., web pages), as this is the dominant protocol and “defacto distributed storage access mechanism”.

Indexing methodologies typically present a simple or hierarchal list of categories, subcategories, and finally a list of references to content. Most commonly, the index is authored by humans, who make conscious choices on the structure and final content of the index. As a history text is biased by the viewpoint of its authors, and limited by his/her knowledge of events, so to is the Internet index biased by the point of view of its author and limited by their knowledge of a vast sea of information content. An index has the advantages that it is reasonably well organized but limited in scope to a manageable degree. What is immediately suspect in any index is its ability to completely map an ever increasing and dynamically changing resource of information. The bias and intentions of the author may also be suspect. Although an index may be very useful, it is unlikely that a manually generated index would effectively map more than a small fraction of a large and dynamic Internet content space.

Search engine methodology provides an alternative to simple indexing schemes. The user community has become increasingly dependent upon the use of search engines. A plethora of engines exist, as well as variations in the algorithms used. The most popular and effective search engines operate on the textual content of web pages. These use a variety of methodologies, including crawlers, spiders, and lexical analysis to collect and create searchable lexicons that map to content in the form of web links (Universal Resource Locators ((URLs)). Because automation is used to seek content, text based search engines are more likely to map a larger content space of a huge and dynamically changing Internet. Full text search engines have a completeness advantage over simple indexing methods. However, this advantage can turn to disadvantage due to the confusion caused by excessive volumes of returned results.

Increasingly, search engines are manipulated (biased) by paid-placement services which are used to find the search provider's business. A subscriber pays the search engine service to insure that links to their web content are positioned in a way as to direct users to their sites, to the exclusion of other non-subscribing sites which are pushed down in the excessively long list of returned results. Third party placement services, unaffiliated with the search service may also act to manipulate search results by the inclusion of high frequency search string keywords that increase the likelihood of match, regardless of the actual relevance of textual content. Both business practices and technological loopholes act to make full text searches suspect in terms of the unbiased nature and relevance of matches to users.

In both the simple a priori indexing, and full text methodologies, the bias is increasingly directed in the favor of those with the ability to pay for placement. This acts to the detriment of smaller businesses and individuals who are unable to pay the increasing cost of placement. The present invention is intended to provide a more level playing field, reduce bias, and broaden scope while increasing relevance as perceived by the user.

Therefore, a need exists to provide a method, system, and/or computer useable medium to facilitate name preservation across an unrestricted set of TLDs. The related art is represented by the following references of interest.

U.S. Patent Application Publication No. 2002/021947 A1, published on Sep. 13, 2001 for Se Ki Kim, describes a method for searching for a domain in the Internet, which lists a search result in the Internet, based on not a general information classification method but a domain name so that a classification standard is clarified. The Kim application does not suggest a method, system, and/or computer useable medium to facilitate name preservation across an unrestricted set of TLDs according to the claimed invention.

U.S. Patent Application Publication No. 2001/0025320 A1, published on Sep. 27, 2001 for Ching Hong Seng et al., describes methods and apparatus that detect the linguistic encoding type of a digital string encoding a domain name. The Seng et al. application does not suggest a method, system, and/or computer useable medium to facilitate name preservation across an unrestricted set of TLDs according to the claimed invention.

U.S. Patent Application Publication No. 2001/0039543 A1, published on Nov. 8, 2001 for Michael Mann et al., describes systems and methods for facilitating generation, registration, and/or transmission of available domain names. The Mann et al. application does not suggest a method, system, and/or computer useable medium to facilitate name preservation across an unrestricted set of TLDs according to the claimed invention.

U.S. Patent Application Publication No. 2002/0010795 A1, published on Jan. 24, 2002 for Charles P. Brown, describes a method and system to protect domain names. The Brown application does not suggest a method, system, and/or computer useable medium to facilitate name preservation across an unrestricted set of TLDs according to the claimed invention.

U.S. Patent Application Publication No. 2002/0065903 A1, published on May 30, 2003 for Barry Fellman, describes a system and method for querying a database for multiple names submitted at one time to a query server. The Fellman application does not suggest a method, system, and/or computer useable medium to facilitate name preservation across an unrestricted set of TLDs according to the claimed invention.

U.S. Patent Application Publication No. 2002/0073233 A1, published on Jun. 13, 2002 for William Gross et al., describes methods and systems used to provide top-level domain names over and above those specified by the Internet Corporation for Assigned Names and Numbers (ICANN) or other authority authorized to approve standardized top-level domain names. The Gross et al. application does not suggest a method, system, and/or computer useable medium to facilitate name preservation across an unrestricted set of TLDs according to the claimed invention.

U.S. Patent Application Publication No. 2002/0091827 A1, published on Jul. 11, 2002 for Raymond King et al., describes a domain name acquisition and management system and method. The King et al. application does not suggest a method, system, and/or computer useable medium to facilitate name preservation across an unrestricted set of TLDs according to the claimed invention.

U.S. Patent Application Publication No. 2002/0103820 A1, published on Aug. 1, 2002 for Brian Cartmell et al., describes a method, system, and computer readable medium that determines alternatives to a specified textual identifier by identifying and using words and phrases that are related to the identifier. The Cartmell et al. application does not suggest a method, system, and/or computer useable medium to facilitate name preservation across an unrestricted set of TLDs according to the claimed invention.

U.S. Patent Application Publication No. 2002/0129013 A1, published on Sep. 12, 2002 for C. Douglass Thomas, describes a method and system for monitoring domain name registrations. The Thomas application does not suggest a method, system, and/or computer useable medium to facilitate name preservation across an unrestricted set of TLDs according to the claimed invention.

U.S. Patent Application Publication No. 2002/0152206 A1, published on Oct. 17, 2002 for Carl P. Gusler et al., describes a program and method for enhancing a domain search by increasing the range of search terms to selected synonyms obtained from a standard thesaurus program. The Gusler et al. application does not suggest a method, system, and/or computer useable medium to facilitate name preservation across an unrestricted set of TLDs according to the claimed invention.

U.S. Patent Application Publication No. 2002/0161745 A1, published on Oct. 31, 2002 for Charles G. Call, describes methods and apparatus for disseminating over the Internet product information produced and maintained by product manufacturers using existing universal product codes as access keys. The Call application does not suggest a method, system, and/or computer useable medium to facilitate name preservation across an unrestricted set of TLDs according to the claimed invention.

U.S. Patent Application Publication No. 2002/0173981 A1, published on Nov. 21, 2002 for Brett B. Stewart, describes a system and method for enabling a business to register a domain location to provide location based services to on-site customers. The Stewart application does not suggest a method, system, and/or computer useable medium to facilitate name preservation across an unrestricted set of TLDs according to the claimed invention.

U.S. Patent Application Publication No. 2003/0115040 A1, published on Jun. 19, 2003 for Yue Xing, describes a method for mapping multi-lingual domain names to existing domain names of an Internet network system. The Xing application does not suggest a method, system, and/or computer useable medium to facilitate name preservation across an unrestricted set of TLDs according to the claimed invention.

U.S. Pat. No. 6,125,395, issued on Sep. 26, 2000 to Frank Rosenberg et al., describes a method for identifying a related collection of web sites using domain names on a global computer network. The Rosenberg et al. patent does not suggest a method, system, and/or computer useable medium to facilitate name preservation across an unrestricted set of TLDs according to the claimed invention.

U.S. Pat. No. 6,412,014 B1, issued on Jun. 25, 2002 to William K. Ryan, describes a directory associated with each of a plurality of top level domain names on the Internet. The Ryan patent does not suggest a method, system, and/or computer useable medium to facilitate name preservation across an unrestricted set of TLDs according to the claimed invention.

Canada Patent Application Publication No. 2 355 970 A1, published on Feb. 6, 2003, describes a domain name system using language scripts top level domains and second level domains. The Canada '970 application does not suggest a method, system, and/or computer useable medium to facilitate name preservation across an unrestricted set of TLDs according to the claimed invention.

World International Property Organization (WIPO) Application Publication No. WO 01/20484 A2, published on Mar. 22, 2001, describes methods and apparatus for establishing and maintaining Internet domain name registrations. The WIPO '484 application does not suggest a method, system, and/or computer useable medium to facilitate name preservation across an unrestricted set of TLDs according to the claimed invention.

WIPO Application Publication No. WO 02/37338 A1, published on May 10, 2002, describes a registry-integrated Internet domain name acquisition system. The WIPO '338 application does not suggest a method, system, and/or computer useable medium to facilitate name preservation across an unrestricted set of TLDs according to the claimed invention.

WIPO Application Publication No. WO 02/056132 A2, published on Jul. 18, 2002, describes a domain name acquisition and management system and method. The WIPO '132 application does not suggest a method, system, and/or computer useable medium to facilitate name preservation across an unrestricted set of TLDs according to the claimed invention.

None of the above references, taken either singly or in combination, is seen to describe the instant invention as claimed. Thus a method, system, and/or computer useable medium to facilitate name preservation across an unrestricted set of TLDs solving the aforementioned problems is desired.

### SUMMARY OF THE INVENTION

The present invention is a method, computer useable medium, and/or system to facilitate name preservation across an unrestricted set of TLDs. TOP LEVEL DOMAIN TOPOLOGY (TLDT) software is executed in a TLDT system. A predetermined secondary level domain name/inclusive name space for a particular TLD is chosen to register. Data is retrieved for the desired secondary level domain name/inclusive name space to register the secondary level domain name/inclusive name space in association with at least one TLD in at least one of a Public Root and/or an Internet Corporation for assigned Names and Numbers (ICANN) Root. A search is conducted of at least one of a Public Root and an ICANN Root and it is determined whether the desired secondary level domain name/inclusive name space is associated with any TLDs that exist. The desired secondary level domain name/inclusive name space is registered with all of those TLDs if the user agrees to pay the periodic fee.

Accordingly, it is a principal aspect of the invention to provide a method, system, and/or computer useable medium method to facilitate name preservation across an unrestricted set of TLDs. TLDT software is executed in a TLDT system. A predetermined secondary level domain name/inclusive name space for a particular TLD is chosen to register. Data is retrieved for a desired secondary level domain name to register the secondary level domain name/inclusive name space in association with at least one TLD in at least one of a Public Root and an ICANN Root. A search is conducted of at least one of a Public Root and/or an ICANN Root, and a determination is made whether the desired secondary level domain name/inclusive name space is associated with any TLDs that exist in the ICANN root system and/or the TLDT system. Any TLDs reported that are associated with the desired secondary level domain name/inclusive name space, and any available TLDs that are not associated with the desired secondary level domain name/inclusive name space. It is determined whether payment of a periodic fee will be made to register the desired secondary level domain name/inclusive name space with all TLDs that are not associated with the desired secondary level domain name/inclusive name space. The desired secondary level domain name/inclusive name space is registered with all TLDs that are not associated with the desired secondary level domain name/inclusive name space if the user agrees to pay the periodic fee.

It is an aspect of the invention to provide improved elements and arrangements thereof in a method, system, and/or computer useable medium to facilitate name preservation across an unrestricted set of TLDs for the purposes described which is inexpensive, dependable, and fully effective in accomplishing its intended purposes.

These and other aspects of the present invention will become readily apparent upon further review of the following specification and drawings.

### BRIEF DESCRIPTION OF THE DRAWINGS

FIG. 1 shows the Domain Name System hierarchy and the relationship to Universal Resource Locators.

FIG. 2 shows the relationship between the Public Root and the ICANN root.

FIG. 3 shows the Top Level Domain Topology (TLDT) according to the present invention.

FIG. 4 is a block diagram of the TLDT system according to the present invention.

FIG. 5 is a functional diagram of the TLDT system during a search process according to the present invention.

FIG. 6 is a functional diagram of a cluster of TLD key words during a search process according to the present invention.

FIG. 7 is a functional diagram of a Second Level Domain (SLD) directory during a search process according to the present invention.

FIG. 8 is a functional diagram of key words associated with an SLD according to the present invention.

FIG. 9 is a functional diagram of SLD key words associated with an SLD according to the present invention.

FIG. 10A is a functional diagram of TLD cluster key words being used in a search for redundant TLD databases according to the present invention.

FIG. 10B is a functional diagram of TLD cluster key words being used in a search for non-redundant TLD databases according to the present invention.

Similar reference characters denote corresponding features consistently throughout the attached drawings.

### DETAILED DESCRIPTION OF THE PREFERRED EMBODIMENTS

The present invention is a method, system, and/or computer useable medium to facilitate name preservation across an unrestricted set of TLDs. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

The present invention enables users to obtain unique Top Level Domains (TLDs), Second Level Domains (SLDs), and Third Level Domains (3LDs), that may be associated or personalized with a particular business. A ring, as well as a mesh, star, grid, etc., topology may be used for existing domain name preservation and indexing/organizing of the Internet on a global scale, customized to the web businesses. Registering an SLD or 3LD domain name under one of an available TLD according to the invention also registers the SLD or 3LD under all of the TLDs. An efficient search and retrieval mechanism takes advantage of the unique topology and keyword extensions to the Domain Name System (DNS).

The DNS is a fundamental structural component of the Internet, as is well known to those familiar with the structure of the Internet. The DNS gives each computer on the Internet a domain name, or Internet address, using easily recognizable letters and words instead of numbers, separated by periods, such as companyname.com. The DNS converts the alpha-numeric domain name into its Internet Protocol (IP) numeric equivalent which consists of four strings of numbers (called labels) separated by periods (called dots), e.g. 123.12.123.12.

The DNS is a hierarchical system, similar to a system of computer files. The TLDs maintain lists and addresses of the SLDs just below them. The subordinate SLDs have similar responsibilities for the 3LDs just below them, and so on. In this way, every computer on the Internet gets an Internet address. The TLDs are placed on the right of the farthest right dot. The DNS specifies values for the TLDs, but does not specify the number, size, or value of the lower hierarchical segments, e.g. the SLDs, 3LDs, etc. This is left to individual organizations.

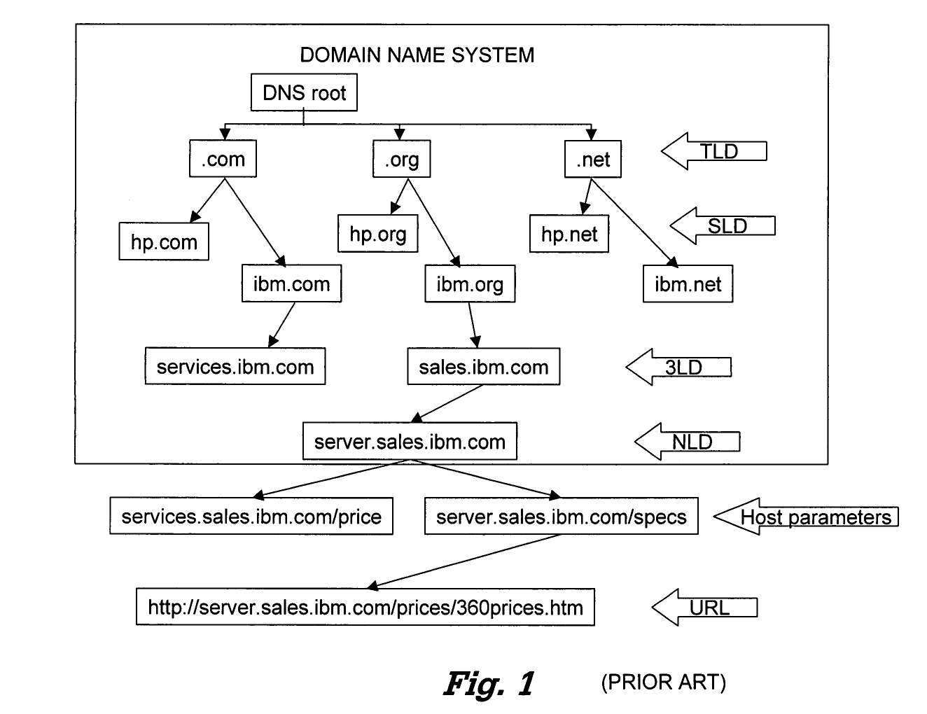

FIG. 1 depicts the DNS hierarchy and its relationship to URLs. The DNS hierarchy represents Internet domain names and is capable of mapping the entire Internet using a distributed database. At the top of the hierarchy is the DNS root or DNS root server system. The DNS root server system is currently a set of thirteen file servers, which together contain authoritative databases listing all TLDs. The name of the root servers are implicit and not reflected in any of the TLDs. Examples of TLDs include such names as “com”, “org”, “net”, etc. These names are defined by a controlling organization by convention and agreement by users of the Internet.

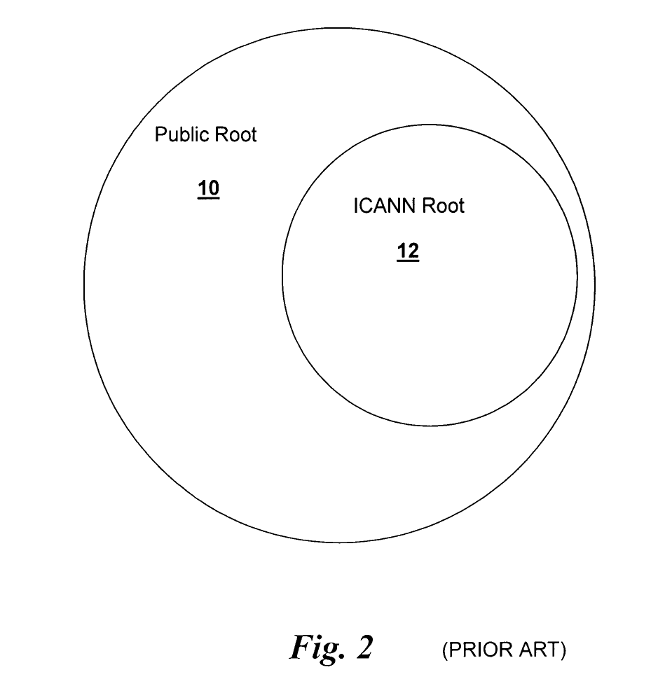

The next level in the hierarchy represents a Second Level Domain (SLD) of the domain hierarchy. The domain names at this level are represented by a combination of two names, the TLD name preceded by a dot and an additional name. The example in FIG. 2 depicts an example of an SLD name in the form of “ibm.com”. The storage medium for the domain names at this level may be implemented as multiple distributed database servers.

The next level in the DNS hierarchy is referred to as a Third Level Domain (3LD), and can be recognized by the presence of two periods in the name (e.g., “servers.ibm.com”). Generally, the hierarchy of names may extend to any number of levels, and may be referred to as NLD. However, the hierarchy of physical servers rarely needs to extend beyond 3LD.

The area below the box representing the DNS in FIG. 1 depicts the way in which fully qualified (complete) domain names contribute to the formation of URL strings. A URL is a superset of a fully qualified domain name in that it includes additional information relevant to information retrieval, including such items as a protocol descriptor prefix and parameters to be passed to the protocol host server such as directory pathnames and other parameters.

The present invention utilizes many of the features of the DNS system and URL protocols in its implementation. By convention, the DNS is managed by a non-profit organization called the Internet Corporation for Assigned Names and Numbers (ICANN). As the administrator ICANN sets policies on such things as the number and names of TLDs within the DNS root that they manage as well as the price of registration. They also delegate responsibility for the management of subsets of the namespace to affiliates, who in turn are responsible for management of certain TLDs.

Other alternative roots are possible, from a legal and technical standpoint. One such alternative DNS root is known as “The Public Root”. The Public Root uses the same technology as the ICANN root, but applies different administrative policies. Once such difference is that the Public Root allows the delegation of management of a less restricted set of TLDs.

As shown in FIG. 2, the Public Root 10 is a compatible superset of the ICANN Root 12. This means that the Public Root 10 encapsulates the data of the ICANN Root 12 in such a way as to avoid conflicting names. Conflicting names would cause ambiguity in the association between domain names and IP numbers. The set relationship between the Public Root 10 and the ICANN Root 12 is shown in FIG. 2. The Public Root 10 is able to avoid name collisions with the ICANN Root 12, because the Public Root 10 uses a set of TLD names that differ from those in the ICANN Root 12. The DNS hierarchy and relationship to URL also indicates that uniqueness among TLDs is preserved by a Public Root policy of not allowing the registration of TLDs that are in the ICANN Root 12.

The Public Root 10 may include TLDs such as 007, 1, 2, 21plus, 3, 4, 4help, 4kidz, 4kids, 4life, 4music, 4peace, 4pets, 4play, 4sex, 4style, 5, 5star, 6, 7, 8, 9, aaa, adlt, army, alt, amazon, amber, arc, area51, artist, ask, att, atv, auct, autos, banks, bbb, beatles, bnb, boat, bowl, brazil, bride2b, bmw, bstn, bud, build, camp, cater, cbs, cell, chicago, child, china, cisco, civil, classic, clinic, clubs, cnn, coins, coke, crafts, credit, cruise, cupid, d, dejavu, debt, diet, disney, doh, drug, eat, ebay, ebiz, efile, eloans, elvis, eng, emaps, emc2, eshop, etoys, explore, f, fam, fbi, fitness, flix, fly, ford, fox, g, garden, gene, gold, gym, h, harley, hist, hllywd, hlth, hmo, Honda, hosp, hotels, ibm, icann, inns, intel, ira, irs, h20, hotjobs, hottie, hvymtl, hydro, insure, inv, italian, j, jackpot, jamn, jewlry, k, korea, l, latin, laws, lend, limos, linux, linx, live, loan, lodge, loto, lwyr, m, maps, marina, max, mexico, mlb, mls, mobile, mortg, motels, mtrx, mtv, n, nol, nanny, nascar, nasdaq, navy, nba, nbc, nfl, nhl, nike, nra, nrg, nxgn, nyny, nyse, o, orig, p, paris, pepsi, pets, pga, pic, pitstop, pix, poll, pray, pros, prsnl, q, r, rainbow, reef, reg, relax, rent, rec, retire rlty, rnr, rocknroll, roxu, s, sale, salons, scary, sec, shops, sincity, skynet, slim, smile, snow, sold, sony, soulmate, spas, sprts, stars, startrek, starwars, stats, stop, style, swim, swiss, t, tan, tax, taxis, tec, temp, tix, top10, top40, top100, topx, tokyo, toy, trvl, univ, v, vacation, veg, vegas, vh1, visa, w, wallst, walmart, wedd, whos, wines, wish, wrld, wwjd, xgame, xmas, walmart, y, yahoo, etc.

These relationships are logical in nature, and do not necessarily imply a specific database topology, nor the underlying organization of servers. For example, replication could be used, or inclusion by reference. The widely used DNS software provides much flexibility in actual implementation.

Other possibilities exist to change the organization of domain namespace topology, while preserving the uniqueness of names between the two or more name spaces. One such methodology is replicate, by reference or inclusion, in full or in part, an external namespace under a unique TLD of a separate namespace.

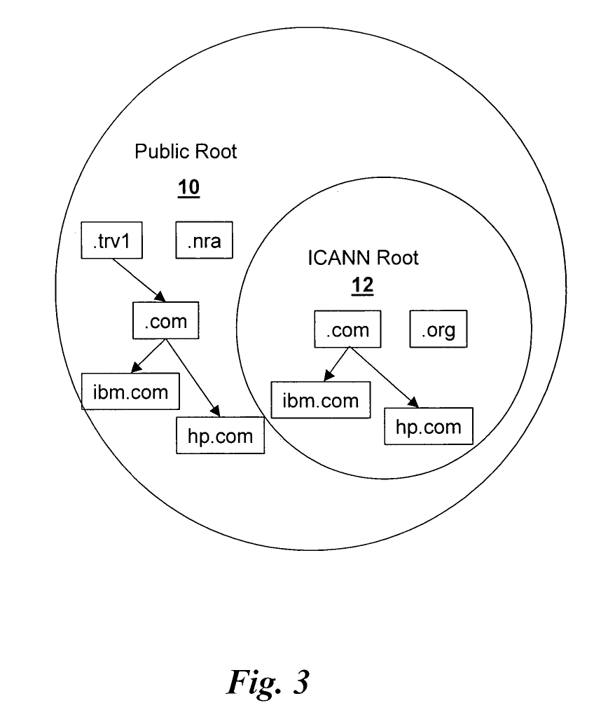

A ring topography of Top Level Domains is shown in FIG. 3. The usefulness of this topography becomes apparent when one takes into consideration the complementation for domain names in a public marketplace. A high recognition name, such as the name “IBM”, is a valuable corporate asset. The memory value of the name “IBM” has been earned by business reputation and advertising. Others might take advantage of the “IBM” name to increase their presence on the Internet. This is done by registering an SLD using the “IBM” name under TLDs that are not currently registered by IBM. The users of this SLD can take advantage of IBM name recognition to redirect Internet inquiries to their own businesses. This is sometimes known as “squatting”.

The problem of squatting is increased in an environment such as the Public Root where the number of TLDs may be significantly larger than a more restricted namespace such as ICANN. By replicating, by reference or inclusion, an SLD under the TLD topography, the value of a corporate name can be preserved, and squatting avoided.

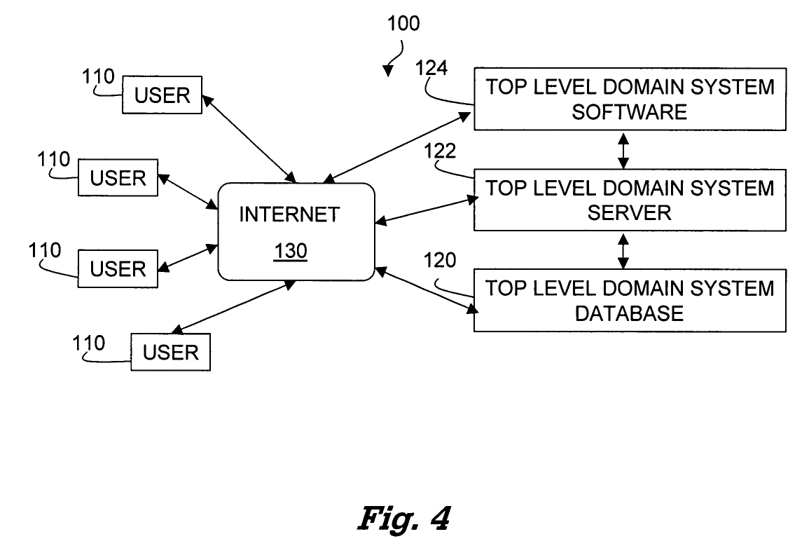

FIG. 4 shows a TLDT system 100 where a variety of users 110 may interconnect with a TLDT website over the Internet 130. The TLDT website is administered by a TLDT database 120 and a TLDT server 122. The TLDT database 120 has stored therein all TLDs presently used by the ICANN root system and the TLDT system 100. The TLDT system 100 is configured to enable a computer system and/or computer useable medium to facilitate name preservation across an unrestricted set of TLDs.

The TLDT server 122 includes stored therein TLDT software 124. The TLDT software 124 may be stored in the memory of the server 122 that may be any combination of random access memory or cache memory. The TLDT software 124 includes a plurality of computer instructions and may additionally be carried on any computer useable medium according to the desires of the user, such as a computer hard drive, a floppy disk, Flash memory, optical memory, magnetic media memory, or the like. The TLDT server 122 includes a processor, an operating system, application programs, and data. In accordance with well known principles, the processor executes the applications in the memory of the TLDT server 122 under control of the operating system.

A variety of users 110 may use the TLDT system 100. Any of the users 110 may utilize a computer device to wirelessly and/or non-wirelessly interconnect with the TLDT website. Such a computer device may be a wireless or non-wireless palm-top, lap-top, personal computer, workstation, or any other similar configured computer device. The computer device may execute standard operating system software, such as Windows 98, 2000, XP, UNIX, LINUX, or the like.

The TLDT software 124 is configured to enable preservation of existing web names and indexing and/or organizing of the Internet on a global scale. When a user accesses the TLDT server 122 the user is initially presented with the TLDT home page. From the TLDT home page, the user may select amongst a variety of options that are displayed in a manner similar to existing registrars. The user may then choose to register a predetermined SLD and/or an inclusive name space (e.g., www.abc.com (3LD.SLD.TLD)) for only one particular TLD. The user then enters the predetermined SLD onto a registry screen.

The TLTD software 124 initially conducts a search of the ICANN server to determine whether the desired SLD is associated with any TLDs that exist in the ICANN root system and/or the TLDT system 100. The user is then informed of any TLDs that are associated with the desired SLD, and any available TLDs that are not associated with the desired SLD. The user then has the option to pay a periodic fee (e.g., a yearly fee or the like) to register the desired SLD with all TLDs that are not associated with the desired SLD. If there are available TLDs in the ICANN root system, a check box may be, presented to the user by the TLDT software to indicate that the TLDT system administration will pay for such available ICANN root system available TLDs. Once the user completes these steps, the TLDT software has reserved the desired SLD for the user for all currently available TLDs in the TLDT system 100 and/or the ICANN root system that are not associated with the desired SLD. For users attempting to register an SLD for which no available SLDs exist, the user will be redirected back to the SLD registration screen with a message indicating that the chosen SLD is not available for registration.

Users 110 who already have SLDs registered in the ICANN root system via another registrar, they may transfer their SLD registrations to the TLDT system 100. To do this, the TLDT software requires the user to verify ownership of the associated SLDs. Once ownership of the associated SLDs is verified, the TLDT software transfers the SLDs to the TLDT system and also registers the SLDs to any available TLDs in the TLDT system and/or the ICANN root system for a predetermined fee. The verification process may be automated to enhance ease and convenience for the user. The TLDT software is also configured to enable users to choose not to activate, associate, and/or list a registered SLD with selective TLDs.

The TLDT system 100 enables a particular registered SLD to revolve under all available TLDs that do not have the particular SLD associated therewith even if the SLD owner chooses not to activate, associate, and/or list the particular SLD under each available TLD. The difference between an activated and a non-activated SLD is that a non-activated SLD under a particular TLD is skipped in a search query. For example, say xxxx company decided that the only TLDs needed to be listed under are .civil, .lawyer, and .hlth because the business is a law office dealing with civil and health related law. The xxxx company could register it's SLD under the three TLDs during the SLD keyword setup, in which they would have a predetermined total number of keyword boxes, such as a total of thirty keyword boxes when ten boxes are linked to each TLD.

The user can choose to set up one series or a set of SLD keywords and have the option for that set to be linked to the other two TLDs to ease account management. The user will still come up in the SLD directory regardless of which or how many TLDs it is under, the TLD being irrelevant. The SLD owner can access and/or see from one web page all of their settings and control options. On this page the SLD owner may also be able to list (like a phone book) not only which zip code they want to associate to, have a national listing choice, international listing choice, but also (like a phone book) which categories the user wants to be listed/indexed under a topic. Once the SLD name is registered in the TLDT system, the SLD is already listed in the SLD directory and/or a category such as plumbers, theaters, hospitals, lawyers, auto dealers, etc.

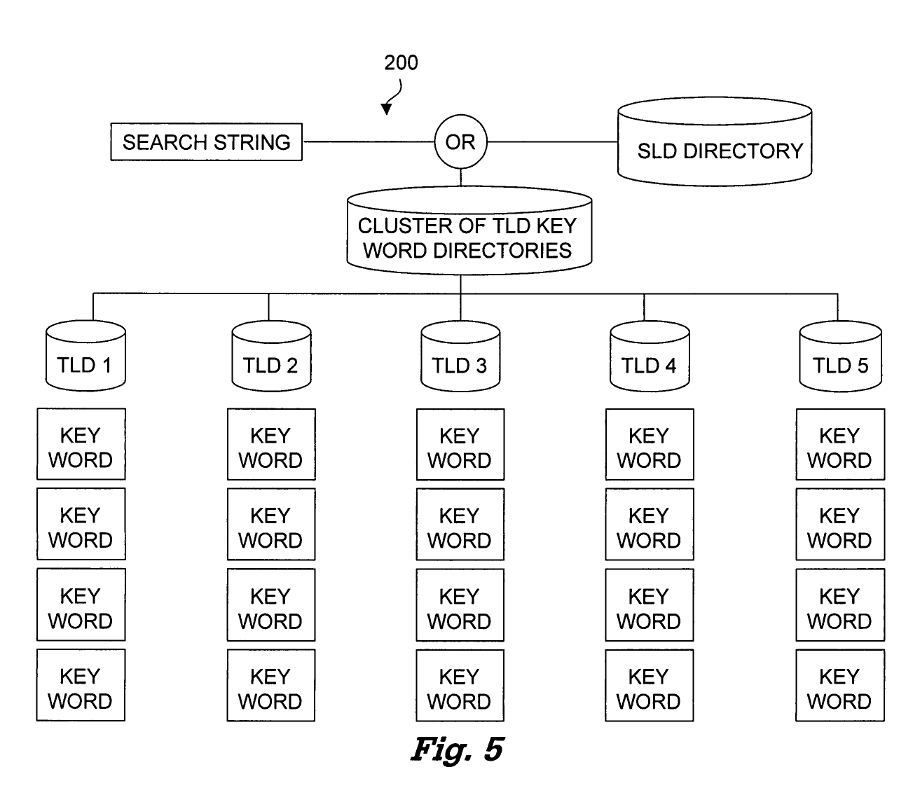

The searching feature utilized by the TLDT software 224 is unique because it is configured to rapidly determine which TLD may contain the most perfect match or best odds of fulfilling particular multiple user search queries. FIG. 5 shows an example 200 of a cluster of TLD key word directories associated with five particular TLD databases, TLD 1, TLD 2, TLD 3, TLD 4, and TLD 5. While FIG. 5 only shows five TLD databases, any number of TLD databases may be included.

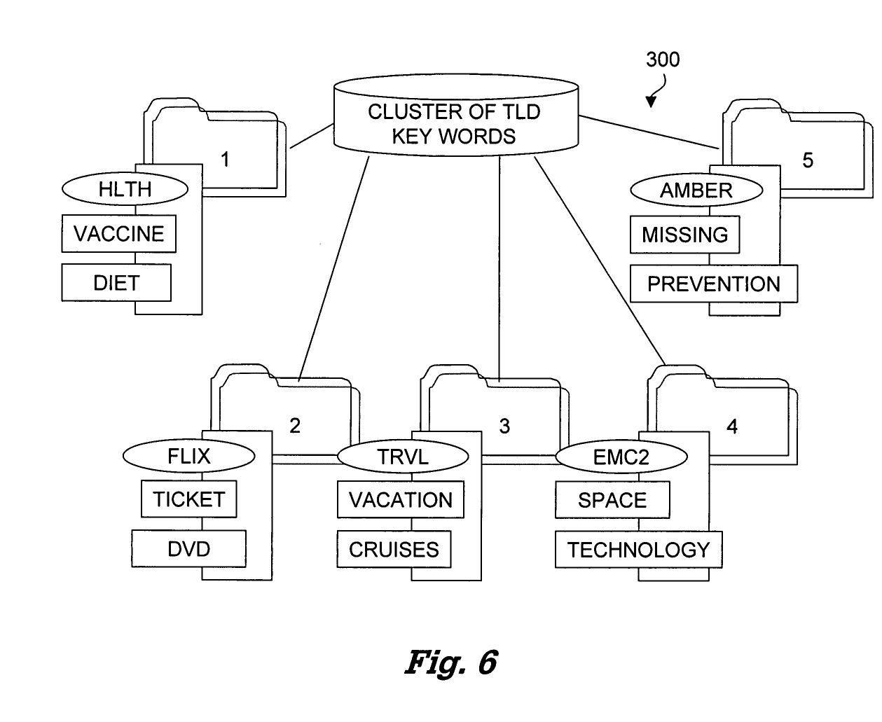

The example 300 shown in FIG. 6 reflects five TLD databases indicated as HLTH, FLIX, TRVL, EMC2, and AMBER TLDs. Consider ‘vacation’ as an example of desired SLD. Many search string entries may be redundant between multiple user search queries.

As such, administrator's of the TLDT system may designate certain key words to particular TLDs. In FIG. 6, ‘vaccine’ and ‘diet’ are designated key words for the HEALTH TLD, ‘ticket’ and ‘dvd’ are designated as key words for the FLIX TLD, ‘vacation’ and ‘cruises’ are the designated keywords for the TRVL TLD, ‘space’ and ‘technology’ are the designated key words for the EMC2 TLD, and ‘missing’ and ‘prevention’ are the designated key words for the AMBER TLD.

For this example, a search string query including the word vacation may have an 80% chance of being located under the TRVL TLD, a 10% chance under the HLTH TLD, and a 5% or less chance under the remaining TLDs. Due to the high percentage of finding a perfect string match under the TRVL TLD, SLDs containing ‘vacation’ under the TRVL TLD are subsequently searched. If the search string has two words and one of those words is found within the cluster for a particular TLD, then the search for both words will continue through that TLD database by comparing the search string against each designated key word for that TLD. If one word is found under an SLD a 50% match would result, and if both words are found a 100% match would result. The TLDT software then reports back the URL either associated to the SLD or the SLD could link a separate URL to a key word or both, and this would be reported to the user.

If a search string has two words and both words are found within two separate TLD clusters, the search involves two simultaneous searches under the two TLDs. Both words in the search string are compared to each designated key word for the associated TLD databases. A perfect match is only found if both search string words are found within the designated key words for a particular SLD. Perfect matches are reported for both TLD databases.

If a search string has three or more words the same process occurs and only a perfect match is reported if all search string words are linked to a particular SLD. If two out of there keywords are found this is reported, but not as a perfect match. If a search string contains words not found in any TDL cluster then the search scans through all TLD databases looking for SLD key word matching, and the results are displayed. If a keyword is found in several clusters then the clusters are searched simultaneously. The TLDT software executes a searching algorithm that first combs through the TLD clusters looking for common words to help accelerate the SLD pinpointing process. Once the best odds are determined for a search string match, a search of the associated database is initiated by comparing each SLD key word association to the search string. The user also has the option in any search to scan the entire database in which all TLD databases would be scanned simultaneously.

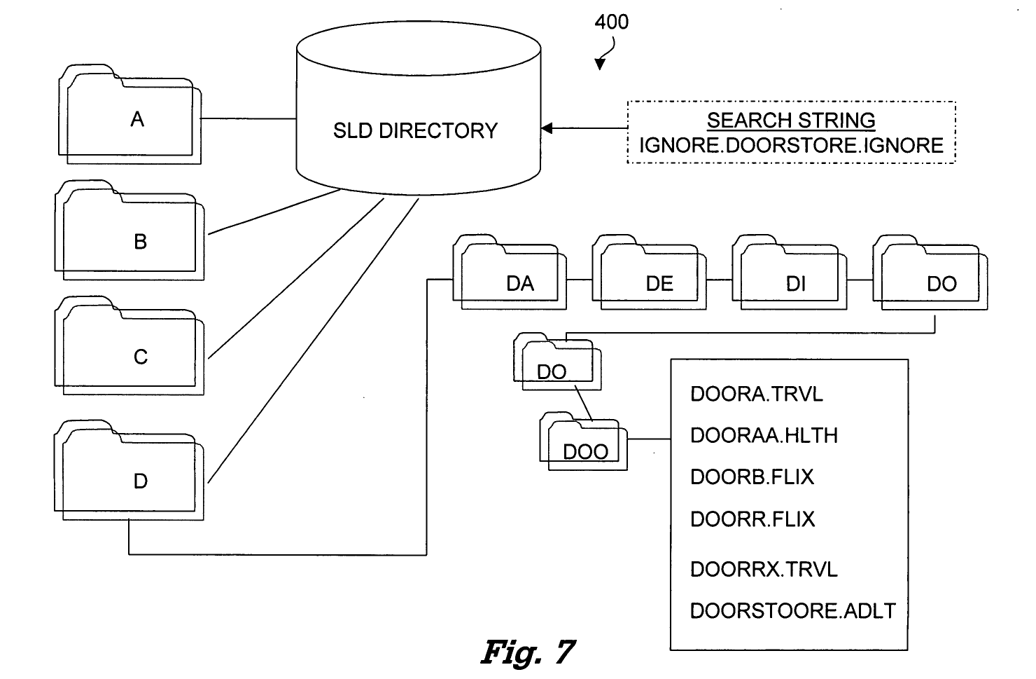

During a search, the TLDT software 124 examines an SLD directory by honing in on an SLD, and disregarding 3LD and TLD unless they are included in the search string. FIG. 7 illustrates an example 400 where the search string includes the words ‘doorstore’. The TLD is irrelevant because otherwise the result to the user would include the SLD and every TLD it was listed under. Once an SLD is registered the TLDT software reserves it's name under all of the TLDs, therefore making it redundant and irrelevant.

The folders labeled A, B, C, and D represent the alphabetical order of the search at the first level. The folders under D represent the most common beginnings to the particular SLD, which is utilized by the TLDT software to speed up the search process. For the word ‘doorstore’, the SLD search recognizes the first letter leading to the first level or main folder D. The second letter in the search string is recognized and leads to thee sub folder (second level) DO. In this example, DA, DE, DI, DO, DR, and DU are the most common letters used in SLDs beginning with D. The next most common letters used in an SLD beginning with DO is DOO. This bypasses the need to search any third letter of SLDs that do not include O (DO‘O’), as in DOA, DOB, DOC, DOD, DOE, etc. The search continues this process until the SLD is found or the next closest SLD to it.

The results are reported to the user by listing the closest match first, in which case an exact match if found this would be first, followed by other closest results.

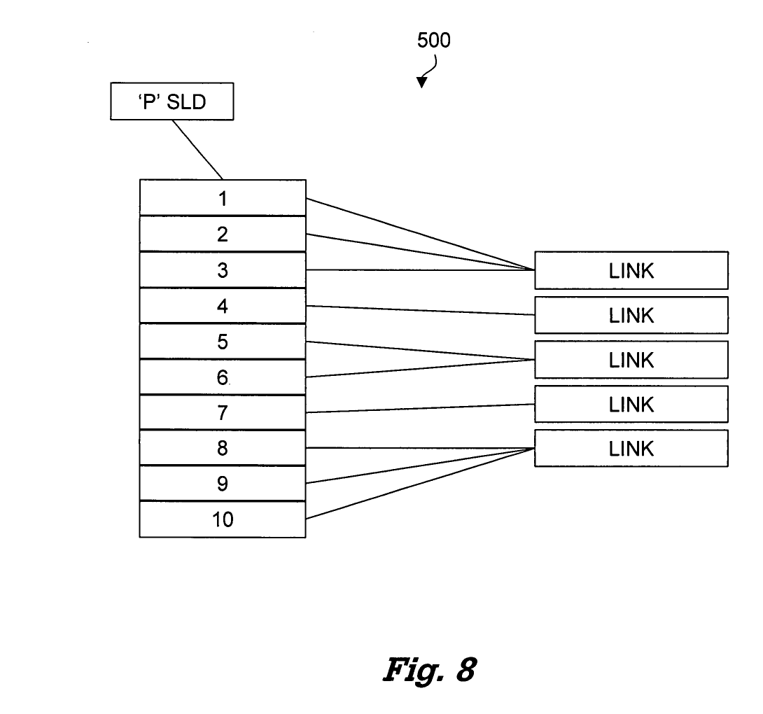

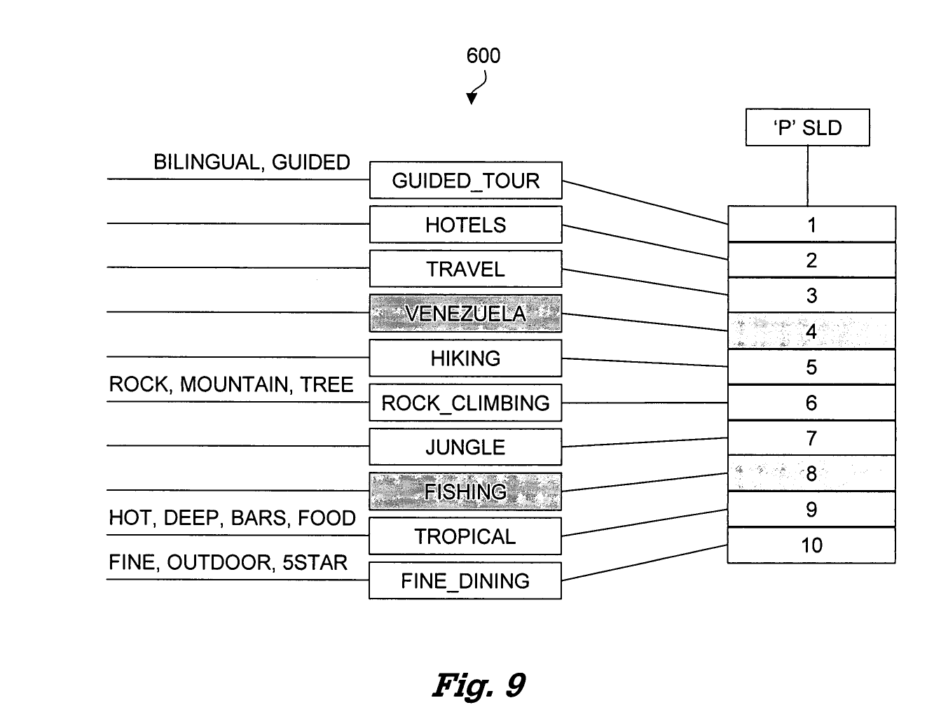

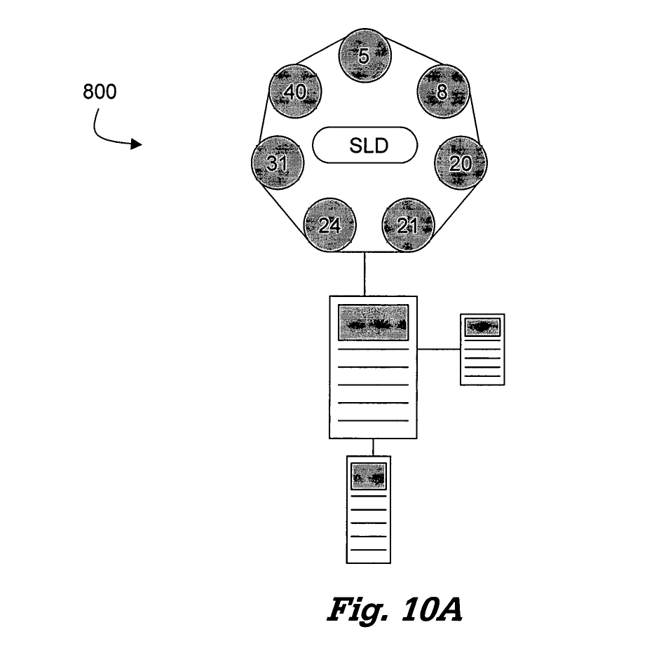

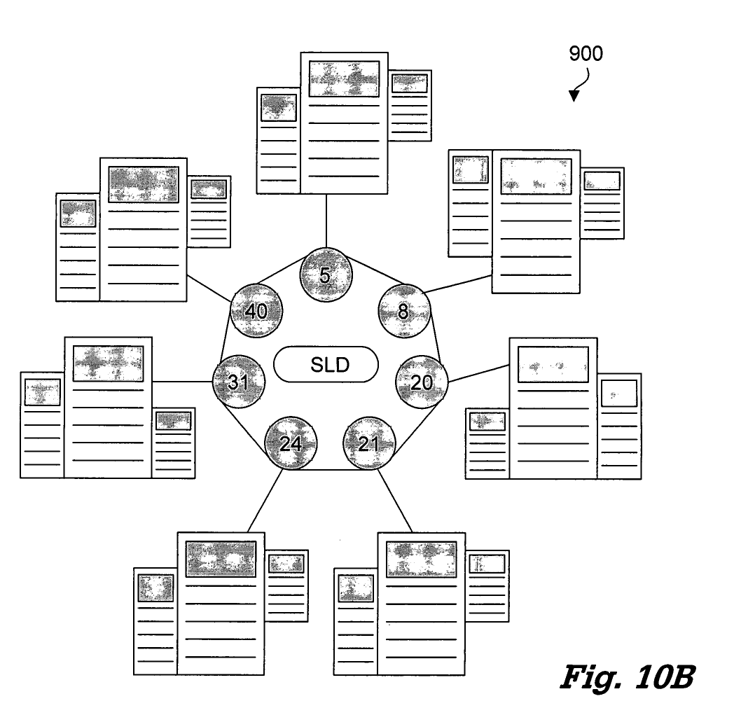

FIG. 8 is a functional diagram 500 of key words associated with an SLD. FIG. 9 is a functional diagram 600 of SLD key words associated with an SLD. FIG. 10 is a functional diagram 700 of SLD key words. FIG. 11A is a functional diagram 800 of TLD cluster key words being used in a search for redundant TLD databases. FIG. 11B is a functional diagram 900 of TLD cluster key words being used in a search for non-redundant TLD databases.

When a user wants to buy an SLD name an SLD database for an associated TLD is searched. If the name is reserved in the ICANN root system it is also reserved in the TLDT system. This process keeps the value and quality of an SLD no matter which root is used. One hundred different SLDs named Yahoo are not needed because they are under one hundred different TLDs. The TLDT software is configured to discourage squatters through this process. By using the public root the TLDT system can organize the entire Internet, while cleaning the ‘noise’ of the Internet that causes multiple search confusions.

In the example 500 shown in FIG. 8, the search algorithm searches downward through each SLD's designated key words (3LDs), labeled with the number one through ten, under whichever TLD database has been chosen for the best search string match provability. In this case the SLD owner could have one main URL for all of the designated key words. In this case the desired SLD (‘P’) has two matches regarding the search string. If the search string contains two words it will search for each of these key words under each SLD located in the TLD database. The illustrated SLD is a perfect match because the two search string words have in fact been found under the SLD. If only one key word was found then the match would be 50% and a result would likely not be sent to the user. If the search string has three words in it then the match would only be 67% of a perfect match.

When all of the SLD databases have been searched within the particular TLD database, the results of URL provability are displayed to the user (the URL associated to the keyword is displayed to the user). In this case the fourth and eighth clusters may not be linked to the same URL. However, they are a perfect match under this SLD because all ten keywords revert back to the same SLD.

The search result is displayed to the user with the URL directly associated to the SLD. This is displayed with the SLD main URL along with the other direct key words if linked to other URLs. For example, consider the search query ‘fishing’‘Venezuala’, and suppose that ‘www.xxx.trvl’, ‘fishing.xxxx.trvl’, and ‘venezuala.xxxx.trvl’ are all under the same SLD. ‘www.xxx.trvl’, ‘fishing.xxxx.trvl’, and ‘venezuala. xxxx.trvl’ are results that would be displayed to the user. The same results would also be displayed if the search query was ‘Venezuala’ ‘fishing’ (the word order makes no difference). The public root ‘www.xxx.trvl’ is displayed regardless of the actual DNS location the URL is under. The TLDT software knows the URL, however the conversion to the 3LD.SLD.TLD format is displayed, and the URL is linked to this or in other words converted.

If the search string is found in several TLD keyword clusters, and the different TLD databases had matching results, this would be displayed. For example, again consider the search query ‘fishing’ ‘Venezuala’, and suppose that ‘www.xxx.trvl’, ‘fishing.xxxx.trvl’, and ‘venezuala.xxxx.trvl’ are all under the same SLD, ‘www.yyyy.trvl’ is linked to the main URL and not the keyword, ‘www.tttt.hlth’ is found under a different TLD database, and ‘www.wrwr.flix’ is found under a different TLD. Results displayed to the user would include ‘www.xxx.trvl’, ‘fishing.xxxx.trvl’, ‘venezuala.xxxx.trvl’, ‘www.yyyy.trvl’, ‘www.tttt.hlth’, and ‘www.wrwr.flix’.

When the results are displayed, a check box may be returned next to each SLD result so the user can check the box and eliminate that SLD from future returned results when the box is checked. This is helpful when the search query includes key words that are actually not relevant to the search string, such as when numerous page hits are gathered with irrelevant SLD key words. The user may also be prompted to vote relevancy to enable the TLDT administrators to reward SLD owners who are good at key word association. Statistics of the SLD databases may be obtained to enable the TLDT administrators to adjust the TLD clusters to obtain better ‘result odds’.

The LINK cells shown in FIG. 8 effectively assist the TLDT service 100 in cleaning Internet noise and confusion for the users. Consider an Internet web site for an intellectual property law firm with a home page entitled ‘patentlaw.com’ and associated web pages about patents, registry, searches, trademarks, copyrights, applications, licensing, jobs, and contacts. The patents web page may be ‘http://www/patentlaw.com/content.aspx?page=3&section=1’. The registry web page may be ‘http://www/patentlaw.com/content.aspx?page=11& section=9’. The searches web page may be ‘http://www/patentlaw.com/content.aspx?page=8&section=6’. The trademarks web page may be ‘http://www/patentlaw.com/content.aspx?page=4&section=2’. The copyrights web page may be ‘http://www/patentlaw.com/content.aspx?page=5&section=3’. The applications web page may be ‘http://www/patentlaw.com/content.aspx?page=10ection=8’. The licensing web page may be ‘http://www/patentlaw.com/content.aspx?page=6&section=4’. The jobs web page may be ‘http://www/patentlaw.com/content.aspx?page=2938&section=22’. The contact web page may be ‘http://www/patentlaw.com/content.aspx? .page=57&section=15’.

The home page ‘patentlaw.com’ could be pasted to a LINK cell and be easy to remember. However, for the patents, registry, searches, trademarks, copyrights, applications, licensing, jobs, and contacts web pages, the search algorithm enables the user to cut and paste each of the respective 3LDs followed by patentlaw.TLD to an associated LINK page to represent the particular web page, e.g., ‘patents.patentlaw.TLD’, ‘registry.patentlaw.TLD’, ‘searches.patentlaw.TLD’, ‘trademarks. patentlaw.TLD’, ‘copyrights.patentlaw.TLD’, ‘applications.patentlaw.TLD’, ‘licensing.patentlaw.TLD’, ‘jobs.patentlaw.TLD’, and ‘contact.patentlaw.TLD’.

Everything after the SLD ‘patentlaw’ for each of the 3LD pages is considered noise and may confuse users or make a particular address for a web page difficult to remember. The search algorithm makes it easier for the user to remember the SLD web pages and it is more informative and less confusing.

Referring to FIG. 9, an example 600 is illustrated for a better understanding of how key words are associated and/or described for an SLD. From the previous example, it is known that the fourth and eighth cells contain the search string words ‘Venezuela’ and ‘fishing’ which make this SLD a perfect match. Key words may be used to better define the pinpointing process of perfecting the search string result. In FIG. 9, the first cell contains the words ‘Guided_Tour’ (please take note of the underscore between the words). The underscore shows that a 3LD descriptor in that cell is linked to the 3LD resulting in Guided Tour being included in the search string.

Consider the descriptors, located to the left of the 3LD cells, to be activated for search purposes only if the 3LD they are linked to is found in the search string. Basically the descriptors complement the 3LD and cannot be used in a search string without the 3LD to which they are linked. Each of the independent key words within cells may be combined to form perfect matches, such as Venezuela Hotels, Venezuela Hiking, Jungle Travel, and Jungle Fishing, as well as Tropical Fine_Dining, Tropical Guided_Tour, Fine_Dining Hotels, etc. The major significance of this type of search structure is to eliminate the common search problems of the AND/OR factors. The SLD key words may be used in combination with one another. However, the linked key words in a particular cell cannot be used separately, such as Outdoor Hiking, Rock Jungle, Fine Tropical, Jungle Dining, etc. If the search string is ‘Venezuela Rock Climbing’ this would be displayed as a perfect match. If the search string was ‘Fine Travel’ this would not be a perfect match because all three keywords within the two cells would have to be equal to the search string. While there may be only ten cells, the total key word combinations are numerous.

The number of characters that are allowed within each cell may be varied according to the desires of the TLDT system administrators. However, anything within one cell or attached to it is considered as one keyword.

Referring to the tenth cell it is noted that Fine_Dining is a perfect match in all word combinations when the search string is ‘Jungle Fine Dining’ or ‘Fine Jungle Dining’ or any other of these three word combinations. However, ‘Fine’ cannot be separated from ‘Dining’ to make any other cell perfect matches and vice/versa, such as ‘Fine Fishing’. The words ‘Fine’, ‘Outdoor’, and ‘5star’ are linked to the tenth cell. These words are known as descriptive words. The main keyword in cell ten is ‘Dining’ and the descriptive words can be used with ‘Dining’ to create one main keyword, but can only be used to that particular cell and not in combination with any other cells. If the search string is ‘Tropical Outdoor Dining’ this would be a perfect match. Note that the ninth and tenth cells were both used. Tropical has descriptive words linked to it but none are relevant. However, Tropical is a match. In the tenth cell ‘Dining’ is a match and outdoor complements ‘Dining’ making a perfect search string match. If ‘Outdoor’ was linked to ‘Fishing’ and ‘Dining’ then the match would only be 67% perfect since only ‘Tropical’ and ‘Dining’ can be directly linked to other cells. This eliminates search confusions.

SLD cluster rings are equally scalable, flexible, highly customizable, and individually search string personable. FIG. 10A illustrates an example 800 where an SLD cluster ring allows for redundancy information throughout multiple TLD databases in the form of an SLD topology with descriptive words. This example significantly reduces the amount of time required to execute a search for a search string. In FIG. 10B, the cluster ring 900 is non-redundantly used and no time is saved because the difference between all non-redundant single TLD setup rings and multi TLD setups with non-redundant information is equal. This example allows the user to organize a smaller portion of the entire cluster ring.

The user may not want to manage all possible TLD clusters that are available, and this facilitates easier management of non-redundant SLD 3LD information. For this example, there can be a first cluster ring, a second cluster ring, etc., and the cluster rings are for SLD management ease. However, there can not be the same TLD repeated twice per SLD. For example, if the user chooses to have a second cluster ring, the key words could not include 5, 8, 20, 21, 24, 31, and 40. Only unused key words could be used for additional cluster rings. This allows for simplified management or extremely detailed management, and it also allows for zero to slim odds that any SLD should be the same as another. However, while all SLDs have an equal opportunity to be found, the TLDT software facilitates indexing and customizing every business globally. Zip codes, national, and global SLD options may be used for enhancing pinpointing. The search string user also has the option to block an SLD if it's not valid.

Not Accurate Record Contents (NARC) buttons may be used by the search string user to block unwanted SLDs, similar to email/fax Anti-Spam functions. The blocked SLD is moved to a blocked list for the user. The search user may also have their own customizable key word box, e.g., the Linked User Customized Keywords or Linking of Users Customized Keywords (LUCK) box. This works like a net nanny in the sense that the user can add key words they do not want searched no matter what the search string is. For example, the user may have children so no matter what is entered in the search string box the results will not display any words associated to the LUCK box of the user. This option is associated and found within and/or stored in the blocked SLD page. The flip side of the LUCK box is that it allows the user to also store common search string key words. For example, suppose the user sets the LUCK box to automatically add the search string words fishing, 5 star hotels, car rentals, and hiking. The user can now type in Venezuela/Canada/Alaska, etc., and the LUCK box will associate the search string to the contents of the LUCK box and report the combinations in a search string result. This feature eliminates the need for the search user to retype search string information. This makes the search customizable, easier, and a multi-search feature. The search string zip/country codes are important features because the user may be traveling to an unfamiliar place. These codes may be Global Positioning System (GPS) integrated. They can use a drop down box to identify the desired destination area zip/code and then do a search within that radius.

The entire database may be also be searched without using TLD clusters which predetermine which TLD database or databases are most provable in returning the most direct search results.

Therefore, if a search string user does not find what they are looking for on the first query, it may be due to the cluster directing the search string to the most provable database and therefore the all option search will search all TLD databases simultaneously. The SLD/URL switch enables the user to decide between searching for an SLD or a URL name. This feature enhances search speed and understanding what SLD/URL the user is searching.

The search user may only know part of the SLD name the SLD directory search will return and/or the exact match with the next closest SLDs. There may be two buttons before the search string. The first is a LUCK box green button. This button is the on/off button for the search users list of words to the search string. The second button is the LUCK box red button and is used for words to display no matter what is typed into the searched string. This can be used for a net nanny and/or search string key words the user is not interested in and are therefore ignored/blocked. This option can be controlled with an on/off within the users account the TLDT system is in a net nanny mode. Inside the users account the zip/country codes can be also blocked to a certain radius, e.g, a default radius.

While the invention has been described with references to its preferred embodiment, it will be understood by those skilled in the art that various changes may be made and equivalents may be substituted for elements thereof without departing from the true spirit and scope of the invention.

1. A method to facilitate name preservation across an unrestricted set of Top Level Domains (TLDs), said method comprising:
executing TOP LEVEL DOMAIN TOPOLOGY (TLDT) software in a TLDT system;
choosing to register a predetermined secondary level domain name/inclusive name space (SLD name) for a particular TLD;
retrieving data for a desired secondary level domain name to register the SLD name in association with at least one TLD in at least one of a Public Root and an Internet Corporation for assigned Names and Numbers (ICANN) Root;
conducting a search of at least one of a Public Root and an ICANN Root and determining whether the desired SLD is associated with any TLDs that exist in the ICANN root system and the TLDT system;
reporting any TLDs that are associated with the desired SLD, and any available TLDs that are not associated with the desired SLD;
determining whether payment of a periodic fee will be made to register the desired SLD with all TLDs that are not associated with the desired SLD; and
registering the desired SLD with all TLDs that are not associated with the desired TLD payment if the periodic fee will be made:

2. The method according to claim 1, wherein the conducting a search of at least one of a Public Root and an ICANN Root step further comprises designating a cluster of TLD key word directories associated with predetermined TLD databases.

3. The method according to claim 2, wherein the conducting a search of at least one of a Public Root and an ICANN Root step further comprises determining a percentage chance of success in searching a particular TLD.

4. The method according to claim 3, wherein the conducting a search of at least one of a Public Root and an ICANN Root step further comprises reporting the percentage chance of success in searching a particular TLD.

5. The method according to claim 1, wherein the determining whether payment of a periodic fee will be made further comprises presenting a check box to a user to indicate that TLDT system administration will pay for SLDs available from the ICANN root system for associated TLDs.

6. The method according to claim 1, wherein the registering the desired SLD with all TLDs that are not associated with the desired TLD further comprises registering the desired SLD with all TLDs that are not associated with the desired SLD.

7. A TOP LEVEL DOMAIN TOPOLOGY (TLDT) system to facilitate name preservation across an unrestricted set of Top Level Domains (TLDs), said system comprising:
a computer useable medium; and
a computer device having a processing unit;
wherein said computer useable medium carries thereon TLDT software to facilitate name preservation across an unrestricted set of Top Level Domains, which, when executed by the processing unit, causes the processing unit to carry out steps comprising:
executing the TLDT software in the TLDT system;
choosing to register a predetermined secondary level domain name/inclusive name space (SLD name) for a particular TLD;
retrieving data for a desired secondary level domain name to register the SLD name in association with at least one TLD in at least one of a Public Root and an Internet Corporation for assigned Names and Numbers (ICANN) Root;
conducting a search of at least one of a Public Root and an ICANN Root and determining whether the desired SLD is associated with any TLDs that exist in the ICANN root system and the TLDT system;
reporting any TLDs that are associated with the desired SLD, and any available TLDs that are not associated with the desired SLD;
determining whether payment of a periodic fee will be made to register the desired SLD with all TLDs that are not associated with the desired SLD; and
registering the desired SLD with all TLDs that are not associated with the desired TLD payment if the periodic fee will be made.

8. The system according to claim 7, wherein the conducting a search of at least one of a Public Root and an ICANN Root step further comprises designating a cluster of TLD key word directories associated with predetermined TLD databases.

9. The system according to claim 8, wherein the conducting a search of at least one of a Public Root and an ICANN Root step further comprises determining a percentage chance of success in searching a particular TLD.

10. The system according to claim 9, wherein the conducting a search of at least one of a Public Root and an ICANN Root step further comprises reporting the percentage chance of success in searching a particular TLD.

11. The system according to claim 7, wherein the conducting a search of at least one of a Public Root and an ICANN Root step further comprises utilizing LINK cells representing particular web pages.

12. The system according to claim 7, wherein the determining whether payment of a periodic fee will be made further comprises presenting a check box to a user to indicate that TLDT system administration will pay for SLDs available from the ICANN root system for associated TLDs.

13. The system according to claim 7, wherein the registering the desired SLD with all TLDs that are not associated with the desired TLD further comprises registering the desired SLD with all TLDs that are not associated with the desired SLD.

14. A computer useable medium carrying TOP LEVEL DOMAIN TOPOLOGY (TLDT) software to facilitate name preservation across an unrestricted set of Top Level Domains, which, when executed by the processing unit, causes the processing unit to carry out steps comprising:
executing the TLDT software in the TLDT system;
choosing to register a predetermined secondary level domain name/inclusive name space (SLD name) for a particular TLD;
retrieving data for a desired secondary level domain name to register the SLD name in association with at least one TLD in at 11 least one of a Public Root and an Internet Corporation for assigned Names and Numbers (ICANN) Root;
conducting a search of at least one of a Public Root and an ICANN Root and determining whether the desired SLD is associated with any TLDs that exist in the ICANN root system and the TLDT system;
reporting any TLDs that are associated with the desired SLD, and any available TLDs that are not associated with the desired SLD;
determining whether payment of a periodic fee will be made to register the desired SLD with all TLDs that are not associated with the desired SLD; and
registering the desired SLD with all TLDs that are not associated with the desired SLD payment if the periodic fee will 11 be made.

15. The computer useable medium according to claim 14, wherein the conducting a search of at least one of a Public Root and an ICANN Root step further comprises designating a cluster of TLD key word directories associated with predetermined TLD databases.

16. The computer useable medium according to claim 15, wherein the conducting a search of at least one of a Public Root and an ICANN Root step further comprises determining a percentage chance of success in searching a particular TLD.

17. The computer useable medium according to claim 16, wherein the conducting a search of at least one of a Public Root and an ICANN Root step further comprises reporting the percentage chance of success in searching a particular TLD.

18. The computer useable medium according to claim 14, wherein the conducting a search of at least one of a Public Root and an ICANN Root step further comprises utilizing LINK cells representing particular web pages.

19. The computer useable medium according to claim 14, wherein the determining whether payment of a periodic fee will be made further comprises presenting a check box to a user to indicate that TLDT system administration will pay for SLDs available from the ICANN root system for associated TLDs.

20. The computer useable medium according to claim 14, wherein the registering the desired SLD with all TLDs that are not associated with the desired TLD further comprises registering the desired SLD with all TLDs that are not associated with the desired SLD.
